(19) United States
(12) Patent Application Publication
(10) Pub. No.: US 2015/0255865 A1
(43) Pub. Date: Sep. 10, 2015

(54) DECOUPLING CIRCUIT

(71) Applicant: Mitsubishi Electric Corporation, Tokyo (JP)

(72) Inventors: Kengo Nishimoto, Tokyo (JP); Toru Fukasawa, Tokyo (JP); Hiroaki Miyashita, Tokyo (JP)

(73) Assignee: Mitsubishi Electric Corporation, Tokyo (JP)

(21) Appl. No.: 14/433,848

(22) PCT Filed: Sep. 12, 2013
(86) PCT No.: PCT/JP2013/074698

§ 371 Date: Apr. 6, 2015

(30) Foreign Application Priority Data
Oct. 18, 2012 (JP) 2012-230919

(51) Int. Cl. H01Q 1/52

(52) U.S. Cl. CPC H01Q 1/521

(57) ABSTRACT

A first distribution circuit outputs a high frequency signal inputted from an input/output terminal to an input/output terminal and a connecting portion. A second distribution circuit outputs a high frequency signal inputted from an input/output terminal to an input/output terminal and a connecting portion. An end of a transmission line is connected to the connecting portion and the other end of the transmission line is connected to the connecting portion. A first antenna is connected to the input/output terminal, and a second antenna is connected to the input/output terminal.

### FIELD OF THE INVENTION

The present invention relates to a decoupling circuit connected to a plurality of antennas mounted in a wireless communication device or the like. More particularly, it relates to a decoupling circuit that reduces the coupling between two antennas.

### BACKGROUND OF THE INVENTION

In recent years, the need for a multiantenna type technique using a plurality of antennas for transmission and reception in order to achieve application of diversity and MIMO (Multiple Input Multiple Output) has been increasing with improvements in both the speed and the quality of wireless communication systems. In order for the diversity and the MIMO to exert their effects, it is necessary to reduce the coupling between the plurality of antennas to as small as possible, thereby reducing the antenna correlation.

However, in general, because in a case in which a plurality of antennas are mounted in a small region, such as a small communication terminal, the distance between the antennas cannot be sufficiently ensured, the coupling between the antennas becomes strong and the communication performance degrades. A method of connecting a decoupling circuit to antennas and cancelling the coupling via antennas by using the coupling via a circuit to solve this problem is known.

For example, it is known that by configuring a decoupling circuit by using two transmission lines and a reactive element that connects between the lines, the mutual coupling between antennas can be reduced (for example, refer to nonpatent reference 1). Further, there is a method of modifying the shapes of two antennas and connecting between the antennas by using a connecting circuit (reactive circuit), thereby reducing the coupling between the antennas (for example, refer to patent reference 1). In addition, a method of, in a dual-polarized patch antenna, cancelling the coupling via antennas by using the coupling via a directional coupler in order to reduce the coupling between electric supply ports is known (refer to nonpatent reference 2).

### RELATED ART DOCUMENT

### Patent Reference

Patent reference 1: Japanese Unexamined Patent Application Publication No. 2011-205316

### Nonpatent Reference

Nonpatent reference 1: S. C. Chen, Y. S. Wang, and S. J. Chung, “A decoupling technique for increasing the port isolation between two strongly coupled antennas,” IEEE Trans. Antennas Propag., vol. 56, no. 12, pp. 3650-3658, December 2008.
Nonpatent reference 2: K. L. Lau, K. M. Luk, and D. Lin, “A wide-band dual-polarization patch antenna with directional coupler,” IEEE Antennas Wireless Propagat. Lett., vol. 1, pp. 186-189, 2002.

### SUMMARY OF THE INVENTION

### Problems to be Solved by the Invention

A problem with the conventional decoupling circuits is, however, that they reduce the coupling at one frequency in principle, and, when the operating frequency band is wide, the coupling cannot be reduced over the entire band. A problem is that particularly when the phase of the coupling between the antennas varies greatly within the operating frequency band, the coupling cannot be reduced over the entire band.

The present invention is made in order to solve the above-mentioned problem, and it is therefore an object of the present invention to provide a decoupling circuit that can reduce the coupling between antennas over a wide band.

### Means for Solving the Problem

In accordance with the present invention, there is provided a decoupling circuit including first and second distribution circuits each distributing one input between two parts and combining two inputs into one, and a transmission line having a predetermined characteristic impedance, the first distribution circuit having first to third terminals and outputting a high frequency signal inputted from the first terminal to the second and third terminals, the second distribution circuit having fourth to sixth terminals and outputting a high frequency signal inputted from the fourth terminal to the fifth and sixth terminals, and the third terminal being connected to an end of the transmission line and the sixth terminal being connected to the other end of the transmission line, in which a first antenna is connected to the second terminal and a second antenna is connected to the fifth terminal, and a path leading from the first terminal, via the first distribution circuit, the first antenna, space, the second antenna, and the second distribution circuit, to the fourth terminal is defined as a first path and a path leading from the first terminal, via the first distribution circuit, the transmission line, and the second distribution circuit, to the fourth terminal is defined as a second path, and in which the distribution ratios of the first distribution circuit and the second distribution circuit are determined in such a way that a coupling amplitude in the first path and a coupling amplitude in the second path become equal, and the length of the transmission line is also determined in such a way that a coupling phase in the first path and a coupling phase in the second path become opposite to each other within a range between an upper limit frequency and a lower limit frequency of an operating frequency band and a difference between the coupling phase at the upper limit frequency of the above-mentioned operating frequency band and the coupling phase at the lower limit frequency becomes equal between the first path and the second path.

### Advantages of the Invention

Because the decoupling circuit in accordance with the present invention includes the first distribution circuit that outputs a high frequency signal inputted from the first terminal to the second and third terminals, and the second distribution circuit that has the fourth to sixth terminals and outputs a high frequency signal inputted from the fourth terminal to the fifth and sixth terminals, the third terminal is connected to an end of the transmission line and the sixth terminal is connected to the other end of the transmission line, and the first antenna is connected to the second terminal and the second antenna is connected to the fifth terminal, a decoupling circuit that can reduce the coupling between the antennas over a wide band can be provided.

### BRIEF DESCRIPTION OF THE FIGURES

FIG. 1 is a structural diagram showing a decoupling circuit in accordance with Embodiment 1 of the present invention;

FIG. 2 is an explanatory drawing showing an example of an antenna to which the decoupling circuit in accordance with Embodiment 1 of the present invention is applied;

FIG. 3 is an explanatory drawing showing a result of the calculation of the coupling between antennas in the two-element dipole antenna shown in FIG. 2;

FIG. 4 is an explanatory drawing showing the amplitudes and the phases of couplings in paths A and B in the case of applying the decoupling circuit in accordance with Embodiment 1 to the two-element dipole antenna shown in FIG. 2;

FIG. 5 is an explanatory drawing showing a coupling amount in the case of applying the decoupling circuit in accordance with Embodiment 1 to the two-element dipole antenna shown in FIG. 2;

FIG. 6 is an explanatory drawing showing the coupling amount in the case of applying a decoupling circuit described in nonpatent reference 1 to the two-element dipole antenna shown in FIG. 2;

FIG. 7 is a structural diagram showing a decoupling circuit in accordance with Embodiment 2 of the present invention;

FIG. 8 is a structural diagram showing a decoupling circuit in accordance with Embodiment 3 of the present invention;

FIG. 9 is a structural diagram showing a decoupling circuit in accordance with Embodiment 4 of the present invention;

FIG. 10 is a structural diagram showing a decoupling circuit in accordance with Embodiment 5 of the present invention; and

FIG. 11 is a structural diagram showing another example of the decoupling circuit in accordance with Embodiment 5 of the present invention.

### EMBODIMENTS OF THE INVENTION

Hereafter, in order to explain this invention in greater detail, the preferred embodiments of the present invention will be described with reference to the accompanying drawings.

### Embodiment 1

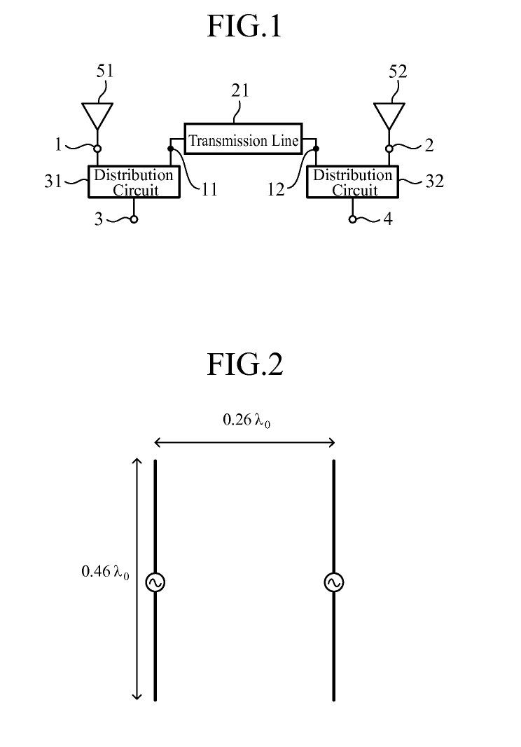

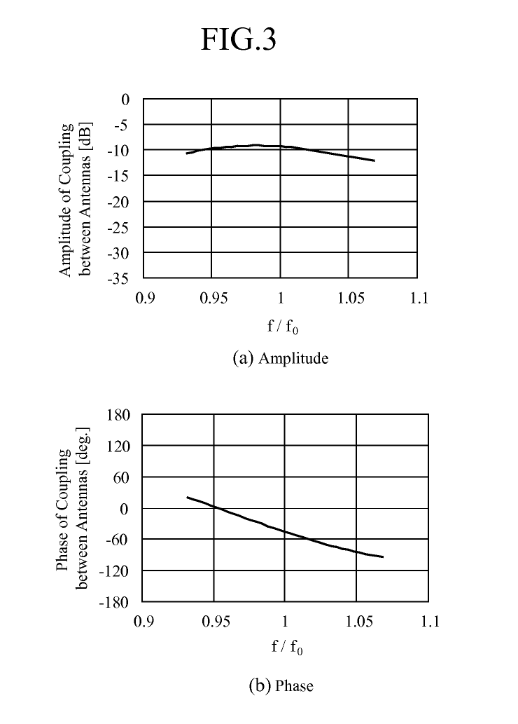

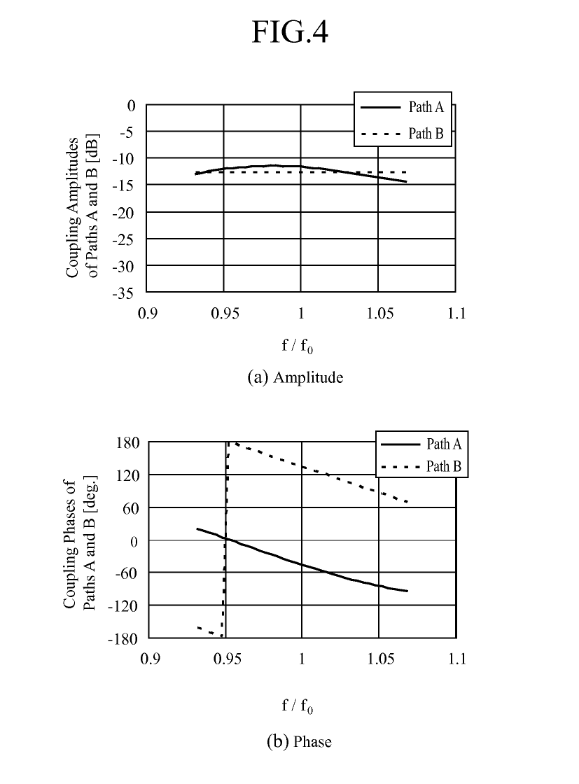

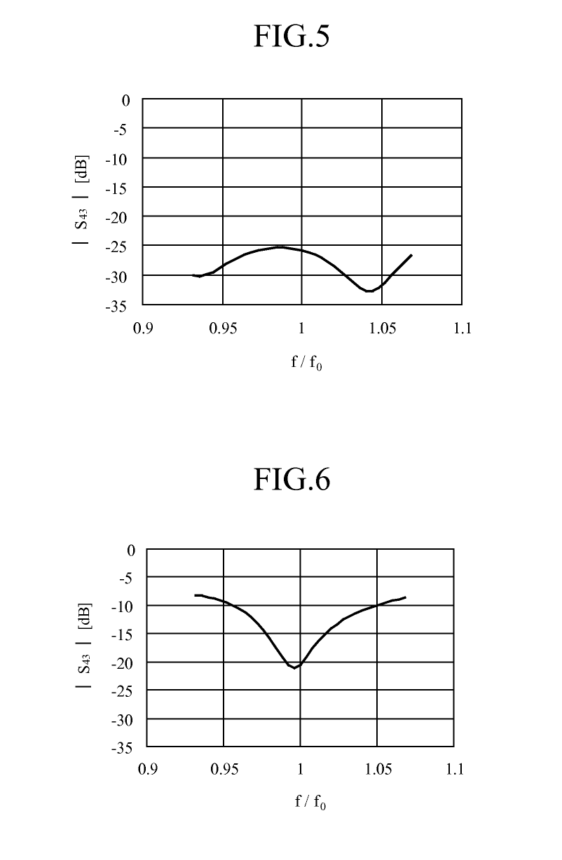

FIG. 1 is a structural diagram showing a decoupling circuit in accordance with Embodiment 1 of the present invention. FIG. 2 is a diagram showing an example of an antenna to which the decoupling circuit in accordance with Embodiment 1 is applied, and shows a two-element dipole antenna. FIG. 3 shows a result of the calculation of the coupling between antennas in the two-element dipole antenna shown in FIG. 2. FIG. 4 shows the amplitudes and the phases of couplings in paths A and B in the case of applying the decoupling circuit in accordance with Embodiment 1 to the two-element dipole antenna shown in FIG. 2. FIG. 5 shows a coupling amount in the case of applying the decoupling circuit in accordance with Embodiment 1 to the two-element dipole antenna shown in FIG. 2. FIG. 6 shows the coupling amount in the case of applying a decoupling circuit described in nonpatent reference 1 to the two-element dipole antenna shown in FIG. 2.

Referring to FIG. 1, input/output terminals 1 to 4, connecting portions 11 and 12, a transmission line 21, and first and second distribution circuits 31 and 32 are disposed in the decoupling circuit in accordance with this Embodiment 1. Further, a first antenna 51 is connected to the input/output terminal 1 and a second antenna 52 is connected to the input/output terminal 2.

Each of the first and second distribution circuits 31 and 32 distributes one input between two parts and combines two inputs into one, and has three terminals. The first distribution circuit 31 has three terminals from first to third. The first terminal is connected to the input/output terminal 3 and the second terminal is connected to a side of the input/output terminal 1 which is opposite to another side connected to the first antenna 51. Further, the third terminal of the first distribution circuit 31 and an end of the transmission line 21 are connected to the connecting portion 11.

The second distribution circuit 32 has three terminals from fourth to sixth. The fourth terminal of the second distribution circuit 32 is connected to the input/output terminal 4. The fifth terminal of the second distribution circuit 32 is connected to a side of the input/output terminal 2 which is opposite to another side connected to the second antenna 52. The sixth terminal of the second distribution circuit 32 and the other end of the transmission line 21 are connected to the connecting portion 12.

Although the design is facilitated if the characteristic impedance of the transmission line 21 is set to be the same (e.g., 50Ω) as a normalized impedance with which the first and second distribution circuits 31 and 32 are designed, the value is not limited hereafter.

Next, the operation of the decoupling circuit in accordance with Embodiment 1 will be explained.

When a high frequency signal is inputted to the input/output terminal 3, the high frequency signal is distributed between the input/output terminal 1 and the connecting portion 11 by the first distribution circuit 31. The high frequency signal distributed to the input/output terminal 1 is inputted to the first antenna 51, and an electromagnetic wave is radiated from the first antenna 51. A part of this electromagnetic wave is received by the second antenna 52 and is inputted to the input/output terminal 2. On the other hand, the high frequency signal distributed to the connecting portion 11 passes through the transmission line 21 and is inputted to the connecting portion 12. The signal inputted to the input/output terminal 2 and the signal inputted to the connecting portion 12 are combined by the second distribution circuit 32, and is outputted to the input/output terminal 4.

Hereafter, a path from the input/output terminal 3→the first distribution circuit 31→the input/output terminal 1→the first antenna 51→the second antenna 52→the input/output terminal 2→the second distribution circuit 32→the input/output terminal 4 is defined as a path A (first path). The coupling from the input/output terminal 3 to the input/output terminal 4 in the path A is expressed by Sₐ₄₃(f)=α(f)e^{jφ(f)}. In this equation, f is a frequency, α(f) is the amplitude of the coupling at the frequency f, and φ(f) is the phase of the coupling at the frequency f. Further, a path from the input/output terminal 3→the first distribution circuit 31→the connecting portion 11→the transmission line 21→the connecting portion 12→the second distribution circuit 32→the input/output terminal 4 is defined as a path B (second path). The coupling from the input/output terminal 3 to the input/output terminal 4 in the path B is expressed by S_{b43}(f)=β(f)e^{jφ(f)}. In this equation, f is the frequency, β(f) is the amplitude of the coupling at the frequency f, and θ(f) is the phase of the coupling at the frequency f.

An operating frequency band is assumed to range from f₁ to f₂. Further, the center frequency in this frequency band is expressed by f₀. First, the distribution ratios of the first distribution circuit 31 and the second distribution circuit 32 are determined in such a way that the coupling amplitude α(f) in the path A and the coupling amplitude β(f) in the path B become nearly equal within the band.

Further, the length L of the transmission line 21 is determined in such a way that the following conditions (1) and (2) are satisfied.

(1) At the center frequency f₀, the coupling phase φ(f₀) in the path A and the coupling phase θ(f₀) in the path B are nearly opposite to each other.

(2) φ(f₂)−φ(f₁)) is nearly equal to (θ(f₂)−θ(f₁)). More specifically, the group delays in the paths A and B are nearly equal.

When the distribution ratios of the first and second distribution circuits 31 and 32 and the length L of the transmission line 21 are determined in the above-mentioned way, the coupling in the path A and the coupling in the path B can be made to have nearly equal amplitudes and nearly opposite phases within the operating frequency band, and the amount of coupling from the input/output terminal 3 to the input/output terminal 4 into which both the couplings are combined can be reduced.

Hereafter, a case, as shown in FIG. 2, in which the two elements in the two-element dipole antennas are arranged at a spacing of 0.26λ₀ will be considered. λ₀ is the free space wavelength at f₀. A result of the calculation of the coupling between the antennas in this case is shown in FIG. 3. FIG. 3 shows the coupling between the antennas in a frequency band ranging from 0.93f₀ to 1.07f₀ in which the VSWR of the antenna is three or less. The phase of the coupling between the antennas varies by 115 degrees within the band. It is assumed that f₁=0.93f₀ and f₂=1.07f₀.

The coupling of the two-element dipole antenna shown in FIG. 2 is reduced by the decoupling circuit shown in FIG. 1. Hereafter, it is assumed that the amount of coupling between the input/output terminal 1 and the connecting portion 11 in the first distribution circuit 31 is 0, the amount of coupling between the input/output terminal 2 and the connecting portion 12 in the second distribution circuit 32 is 0, the reflected amount of each terminal of the first distribution circuit 31 is 0, and the reflected amount of each terminal of the second distribution circuit 32 is 0. Further, it is assumed that the reflected amount in each of the connecting portions 11 and 12 in the transmission line 21 is 0.

It is assumed that the normalized impedances of the first antenna 51, the second antenna 52, the first distribution circuit 31, and the second distribution circuit 32 are 50Ω. It is assumed that in the first distribution circuit 31, the transmission phase from the input/output terminal 3 to the input/output terminal 1 and the transmission phase from the input/output terminal 3 to the connecting portion 11 are equal. It is further assumed that in the second distribution circuit 32, the transmission phase from the input/output terminal 4 to the input/output terminal 2 and the transmission phase from the input/output terminal 4 to the connecting portion 12 are equal. In addition, it is assumed that there is no loss in the transmission line 21, and the characteristic impedance of the transmission line 21 is 50 Ω.

In the first distribution circuit 31, the transmission amplitude (dB) from the input/output terminal 3 to the input/output terminal 1 is expressed by P₁, and the transmission amplitude (dB) from the input/output terminal 3 to the connecting portion 11 is expressed by P₂. In the second distribution circuit 32, the transmission amplitude (dB) from the input/output terminal 4 to the input/output terminal 2 is expressed by P₁, and the transmission amplitude (dB) from the input/output terminal 4 to the connecting portion 12 is expressed by P₂. Further, the mean value of the maximum and the minimum, within the band, of the amplitude of the coupling between the antennas shown in FIG. 3 is expressed by γ (dB). At this time, P₂ is calculated in such a way that the coupling amplitudes in the paths A and B shown in FIG. 1 become nearly equal, according to the following equation.

$${P}_{2} 10 {log}_{10} ( \frac{- {10}^{γ / 10} + \sqrt{{10}^{γ / 10}}}{1 - {10}^{γ / 10}} )$$

Further, P₁=10 log₁₀(1−10^{P}^{₂}^{/10}) is established. In this equation, P₁=−1.2 dB and P₂=−6.3 dB.

The coupling phase φ in the path A is equal to the phase of the coupling between the antennas shown in FIG. 2. By determining the length of the transmission line 21 according to the following equation, the coupling phase in the path A and the coupling phase in the path B become opposite to each other at f₀, and the group delays in the paths A and B become nearly equal. In the following equation, the unit of φ and θ is [deg.] (degree).

$$θ ( {f}_{0} ) = - [ ⌊ \frac{\frac{( φ ( {f}_{1} ) - φ ( {f}_{2} ) ) {f}_{0}}{( {f}_{2} - {f}_{1} )} + φ ( {f}_{0} ) - 180}{360} + 0.5 ⌋ 360 - φ ( {f}_{0} ) + 180 ]$$

$$L = - θ ( {f}_{0} ) {λ}_{0} / ( 360 \sqrt{{ɛ}_{reff}} )$$

where └x┘ is a floor function and is defined as the largest integer equal to or less than x with respect to a real number x. ε_{reff} is the effective relative permittivity in the transmission line 21. In this case, θ(f₀)=945.8 degrees.

The amplitudes and the phases of the couplings in the paths A and B in this example are shown in FIG. 4. It can be recognized that the coupling amplitude is nearly equal between the paths A and B. It can be further recognized that the coupling phase differs by about 180 degrees between the paths A and B within the band, and the group delay (an inclination of the frequency characteristics of the phase) is nearly equal between the paths.

The amplitude of the coupling S₄₃ from the input/output terminal 3 to the input/output terminal 4 (the coupling into which the couplings in the paths A and B are combined) is shown in FIG. 5. It can be recognized that the coupling amount is equal to or less than −25 dB within the band, and the coupling amount is reduced by this decoupling circuit.

The coupling amount in the case in which the decoupling circuit disclosed in nonpatent reference 1 is installed in the two-element dipole antenna shown in FIG. 2 is shown in FIG. 6. It can be recognized that although the coupling amount is equal to or less than −20 dB at the center frequency f₀, the coupling amount degrades as the frequency approaches an end of the band, and the coupling amount cannot be reduced over the entire band.

As mentioned above, because the decoupling circuit in accordance with Embodiment 1 includes the first and second distribution circuits each distributing one input between two parts and combining two inputs into one, and the transmission line having a predetermined characteristic impedance, the first distribution circuit having the first to third terminals and outputting a high frequency signal inputted from the first terminal to the second and third terminals, the second distribution circuit having the fourth to sixth terminals and outputting a high frequency signal inputted from the fourth terminal to the fifth and sixth terminals, and the third terminal being connected to an end of the transmission line and the sixth terminal being connected to the other end of the transmission line, in which the first antenna is connected to the second terminal and the second antenna is connected to the fifth terminal, there is provided an advantage of being able to provide a decoupling circuit that can reduce the coupling between antennas over a wide band.

Further, because in the decoupling circuit in accordance with Embodiment 1, the path leading from the first terminal, via the first distribution circuit, the first antenna, space, the second antenna, and the second distribution circuit, to the fourth terminal is defined as the first path and the path leading from the first terminal, via the first distribution circuit, the transmission line, and the second distribution circuit, to the fourth terminal is defined as the second path, and the distribution ratios of the first distribution circuit and the second distribution circuit are determined in such a way that the coupling amplitude in the first path and the coupling amplitude in the second path become nearly equal, and the length of the transmission line is also determined in such a way that the coupling phase in the first path and the coupling phase in the second path become nearly opposite to each other at the center frequency of the operating frequency band and the difference between the coupling phase at the upper limit frequency of the operating frequency band and the coupling phase at the lower limit frequency of the operating frequency band becomes nearly equal between the first path and the second path, the amount of coupling between the first terminal and the fourth terminal can be reduced.

### Embodiment 2

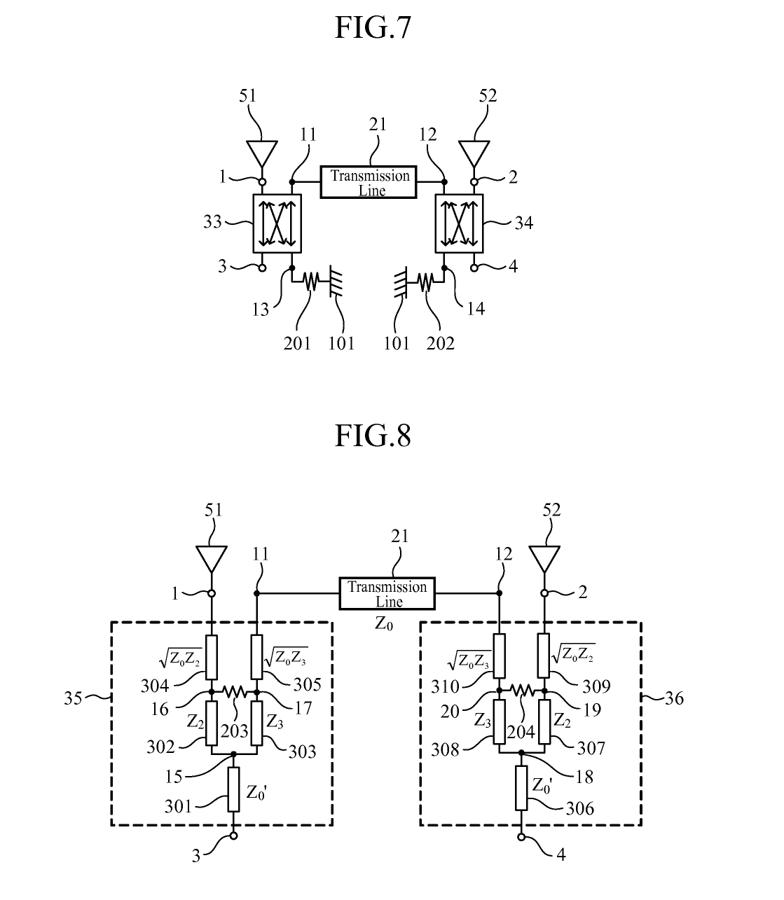

In this Embodiment 2, the first and second distribution circuits 31 and 32 of the decoupling circuit in accordance with Embodiment 1 are first and second directional couplers 33 and 34, respectively. FIG. 7 is a structural diagram showing a decoupling circuit in accordance with Embodiment 2.

Referring to FIG. 7, in the decoupling circuit in accordance with Embodiment 2, the first distribution circuit 31 of the decoupling circuit in accordance with Embodiment 1 is the first directional coupler 33, and the second distribution circuit 32 is the second directional coupler 34. Further, a first termination register 201 whose end is connected to a ground conductor 101 and a second termination register 202 whose end is connected to the ground conductor 101 are disposed. The other structural components are the same as those of Embodiment 1 shown in FIG. 1.

The first directional coupler 33 has four terminals from first to fourth. The first terminal is connected to an input/output terminal 3, and the second terminal is connected to a side of an input/output terminal 1 which is opposite to another side connected to a first antenna 51. Further, the third terminal of the first directional coupler 33 and an end of a transmission line 21 are connected to a connecting portion 11. The fourth terminal of the first directional coupler 33 and the other end of the termination register 201 are connected to a connecting portion 13.

Similarly, the second directional coupler 34 has four terminals from fifth to eighth. The fifth terminal is connected to an input/output terminal 4, and the sixth terminal is connected to a side of an input/output terminal 2 which is opposite to another side connected to a second antenna 52. The seventh terminal of the second directional coupler 34 and the other end of the transmission line 21 are connected to a connecting portion 12. The eighth terminal of the second directional coupler 34 and the other end of the termination register 202 are connected to a connecting portion 14.

More specifically, the first directional coupler 33 outputs a high frequency signal inputted from the first terminal to the second and third terminals, but does not output the high frequency signal to the fourth terminal. The second directional coupler 34 outputs a high frequency signal inputted from the fifth terminal to the sixth and seventh terminals, but does not output the high frequency signal to the eighth terminal.

In the first directional coupler 33, the amount of coupling between the input/output terminal 3 and the connecting portion 13 is very small, and the amount of coupling between the input/output terminal 1 and the connecting portion 11 is very small. Further, in the second directional coupler 34, the amount of coupling between the input/output terminal 4 and the connecting portion 14 is very small, and the amount of coupling between the input/output terminal 2 and the connecting portion 12 is very small.

Because in this way, in the decoupling circuit of FIG. 7, isolation between the input/output terminal 1 and the connecting portion 11 in the first directional coupler 33 is ensured, and isolation between the input/output terminal 2 and the connecting portion 12 in the second directional coupler 34 is ensured, design can be easily performed.

Although the values of the first and second termination registers 201 and 202 are typically set to be the same (e.g., 50Ω) as a normalized impedance with which the first and second directional couplers 33 and 34 are designed, the values are not limited hereafter. Further, the coupling amounts of the first directional coupler 33 and the second directional coupler 34 are determined in such away that the coupling amplitude in the path A and the coupling amplitude in the path B become nearly equal. In addition, the length L of the transmission line 21 is determined in the same way as that shown in Embodiment 1.

As mentioned above, because the decoupling circuit in accordance with Embodiment 2 including the first and second directional couplers, the transmission line, the first and second termination registers, and the ground conductor, the first directional coupler having the first to fourth terminals and outputting a high frequency signal inputted from the first terminal to the second and third terminals, but not outputting the high frequency signal to the fourth terminal, the second directional coupler having the fifth to eighth terminals and outputting a high frequency signal inputted from the fifth terminal to the sixth and seventh terminals, but not outputting the high frequency signal to the eighth terminal, the third terminal being connected to an end of the transmission line and the seventh terminal being connected to the other end of the transmission line, and the fourth terminal being connected to the ground conductor via the first termination register and the eighth terminal being connected to the ground conductor via the second termination register, in which the first antenna is connected to the second terminal and the second antenna is connected to the sixth terminal, there is provided an advantage of being able to provide a decoupling circuit that can reduce the coupling between antennas over a wide band, and that can be designed easily.

Further, because in the decoupling circuit in accordance with Embodiment 2, the path leading from the first terminal, via the first directional coupler, the first antenna, space, the second antenna, and the second directional coupler, to the fifth terminal is defined as the first path and the path leading from the first terminal, via the first directional coupler, the transmission line, and the second directional coupler, to the fifth terminal is defined as the second path, and the coupling amounts of the first directional coupler and the second directional coupler are determined in such a way that the coupling amplitude in the first path and the coupling amplitude in the second path become nearly equal, and the length of the transmission line is also determined in such a way that the coupling phase in the first path and the coupling phase in the second path become nearly opposite to each other at the center frequency of the operating frequency band and the difference between the coupling phase at the upper limit frequency of the operating frequency band and the coupling phase at the lower limit frequency of the operating frequency band becomes nearly equal between the first path and the second path, the amount of coupling between the first terminal and the fifth terminal can be reduced.

### Embodiment 3

In this Embodiment 3, the first and second distribution circuits 31 and 32 of the decoupling circuit in accordance with Embodiment 1 are first and second Wilkinson distribution circuits 35 and 36, respectively. A decoupling circuit in accordance with Embodiment 3 of the present invention is shown in FIG. 8.

Referring to FIG. 8, in the decoupling circuit in accordance with Embodiment 3, the first distribution circuit 31 of the decoupling circuit in accordance with Embodiment 1 is the first Wilkinson distribution circuit 35, and the second distribution circuit 32 is the second Wilkinson distribution circuit 36. In the first Wilkinson distribution circuit 35, transmission lines 301 to 305, a resistor 203, and connecting portions 15 to 17 are disposed. In the second Wilkinson distribution circuit 36, transmission lines 306 to 310, a resistor 204, and connecting portions 18 to 20 are disposed.

An end of the transmission line 301 in the first Wilkinson distribution circuit 35 is connected to an input/output terminal 3. The other end of the transmission line 301, an end of the transmission line 302, and an end of the transmission line 303 are connected to the connecting portion 15. The other end of the transmission line 302, an end of the resistor 203, and an end of the transmission line 304 are connected to the connecting portion 16. The other end of the transmission line 303, the other end of the resistor 203, and an end of the transmission line 305 are connected to the connecting portion 17. The other end of the transmission line 304 is connected to a side of an input/output terminal 1 which is opposite to another side connected to a first antenna 51. The other end of the transmission line 305 and an end of a transmission line 21 are connected to a connecting portion 11.

An end of the transmission line 306 in the second Wilkinson distribution circuit 36 is connected to an input/output terminal 4. The other end of the transmission line 306, an end of the transmission line 307, and an end of the transmission line 308 are connected to the connecting portion 18. The other end of the transmission line 307, an end of the resistor 204, and an end of the transmission line 309 are connected to the connecting portion 19. The other end of the transmission line 308, the other end of the resistor 204, and an end of the transmission line 310 are connected to the connecting portion 20. The other end of the transmission line 309 is connected to a side of an input/output terminal 2 which is opposite to another side connected to a second antenna 52. The other end of the transmission line 310 and the other end of the transmission line 21 are connected to a connecting portion 12.

The electric length of each of the transmission lines 301 to 310 is assumed to be the one-quarter wavelength at the center frequency f₀. In the first Wilkinson distribution circuit 35, the transmission amplitude (dB) from the input/output terminal 3 to the connecting portion 11 is expressed by P₂. In the second Wilkinson distribution circuit 36, the transmission amplitude (dB) from the input/output terminal 4 to the connecting portion 12 is expressed by P₂. The following equation: K=\sqrt{10^{P}^{₂}¹⁰/(1−10^{P}^{₂}^{/10})} is then assumed to be established. Further, the normalized impedance of the decoupling circuit is expressed by Z₀.

At this time, the characteristic impedance Z₀′ of each of the transmission lines 301 and 306, the characteristic impedance Z₂ of each of the transmission lines 302 and 307, and the characteristic impedance Z₃ of each of the transmission lines 303 and 308 are expressed by the following equations.

$${Z}_{0}^{′} = {( \frac{K}{1 + {K}^{2}} )}^{1 / 4} {Z}_{0}$$

$${Z}_{2} = {{K}^{3 / 4} ( 1 + {K}^{2} )}^{1 / 4} {Z}_{0}$$

$${Z}_{3} = \frac{{( 1 + {K}^{2} )}^{1 / 4}}{{K}^{5 / 4}} {Z}_{0}$$

Further, the characteristic impedance of each of the transmission lines 304 and 309 is assumed to be \sqrt{Z₀Z₂}, and the characteristic impedance of each of the transmission lines 305 and 310 is assumed to be \sqrt{Z₀Z₃}. Each of the resistors 203 and 204 is assumed to be Z₀(1+K²)/K.

In the first Wilkinson distribution circuit 35, the amount of coupling between the input/output terminal 1 and the connecting portion 11 is very small. Further, in the second Wilkinson distribution circuit 36, the amount of coupling of the input/output terminal 2 and the connecting portion 12 is very small.

Because in this way, in the decoupling circuit of FIG. 8, isolation between the input/output terminal 1 and the connecting portion 11 in the first Wilkinson distribution circuit 35 is ensured, and isolation between the input/output terminal 2 and the connecting portion 12 in the second Wilkinson distribution circuit 36 is ensured, design can be easily performed.

As mentioned above, because in the decoupling circuit in accordance with Embodiment 3, the first distribution circuit is the first Wilkinson distribution circuit and the second distribution circuit is the second Wilkinson distribution circuit, isolation between the second and third terminals is ensured in the first Wilkinson distribution circuit and isolation between the fifth and sixth terminals is ensured in the second Wilkinson distribution circuit, there is provided an advantage of being able to provide a decoupling circuit that can reduce the coupling between antennas over a wide band, and that can be designed easily.

### Embodiment 4

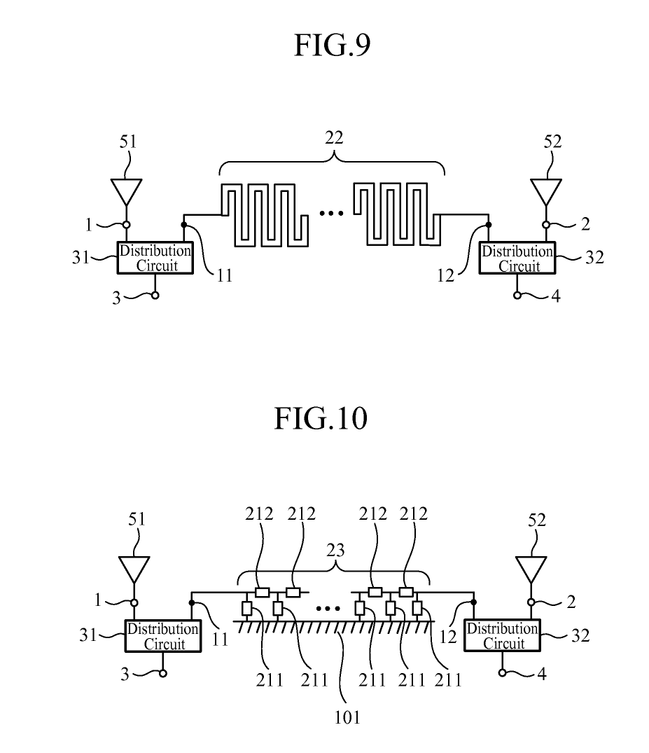

In this Embodiment 4, the transmission line 21 of the decoupling circuit in accordance with Embodiment 1 is a meander line 22. A decoupling circuit in accordance with Embodiment 4 is shown in FIG. 9.

Referring to FIG. 9, in the decoupling circuit in accordance with Embodiment 4, the transmission line 21 of the decoupling circuit in accordance with Embodiment 1 is the meander line 22. Because the other structural components are the same as those of Embodiment 1, corresponding components are designated by the same reference numerals and the explanation of the components will be omitted hereafter.

By configuring the transmission line to be the meander line 22 in this way, the transmission line can be downsized.

As mentioned above, because in the decoupling circuit in accordance with Embodiment 4, the transmission line is a meander line, there is provided an advantage of being able to provide a decoupling circuit that can reduce the coupling between antennas over a wide band, and that is downsized.

### Embodiment 5

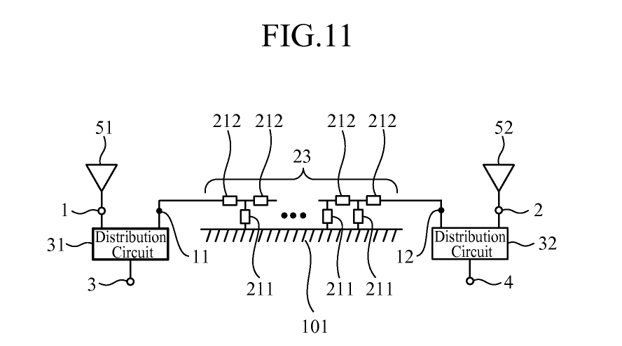

In this Embodiment 5, the transmission line 21 of the decoupling circuit in accordance with Embodiment 1 is a phase shift circuit 23 comprised of a plurality of lumped elements. FIG. 10 is a diagram showing a decoupling circuit in accordance with Embodiment 5 of the present invention, and FIG. 11 is a diagram showing a decoupling circuit in accordance with Embodiment 5 having another structure.

Referring to FIG. 10, in the decoupling circuit in accordance with Embodiment 5, the transmission line 21 of the decoupling circuit in accordance with Embodiment 1 is the phase shift circuit 23 comprised of lumped elements. A plurality of capacitors 211 and a plurality of inductors 212 are disposed in the phase shift circuit 23.

An end of each of the capacitors 211 is connected to a ground conductor 101. Each inductor 212 is placed between capacitors 211, and the other ends of the capacitors 211 which are opposite to the ends connected to the ground conductor are connected to each other via the inductor 212.

Further, while each inductor 212 is placed between capacitors 211 in FIG. 10, each capacitor 211 can be placed between inductors 212, as shown in FIG. 11. More specifically, the phase shift circuit 23 should just have a structure in which a plurality of shunt capacitors 211 and a plurality of series inductors 212 are alternately connected to each other.

Each of T type and n type circuits which is configured by using lumped elements (capacitors and inductors) can be used as the phase shift circuit. Further, by combining a plurality of circuits of these types, the phase shift amount can be enlarged. Circuits that are configured in this way are provided as the phase shift circuits 23 shown in FIGS. 10 and 11, and the phase shift circuits can be downsized because each of them is configured of only lumped elements.

As mentioned above, because in the decoupling circuit in accordance with Embodiment 5, the transmission line is a phase shift circuit comprised of lumped elements, and the phase shift circuit is configured in such a way that a plurality of shunt capacitors and a plurality of series inductors are alternately connected to each other, there is provided an advantage of being able to provide a decoupling circuit that can reduce the coupling between antennas over a wide band, and that is reduced in size.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the decoupling circuit in accordance with the present invention is configured in such a way that the third terminal of the first distribution circuit is connected to an end of the transmission line and the sixth terminal of the second distribution circuit is connected to the other end of the transmission line, and the first antenna is connected to the second terminal of the first distribution circuit and the second antenna is connected to the fifth terminal of the second distribution circuit, a decoupling circuit that can reduce the coupling between antennas over a wide band can be provided, and the decoupling circuit in accordance with the present invention is suitable particularly for use in a case in which the coupling between two antennas is reduced in a decoupling circuit connected to a plurality of antennas mounted in a wireless communication device or the like.

### EXPLANATIONS OF REFERENCE NUMERALS

1 to 4 input/output terminal, 11 to 20 connecting portion, 21, 301 to 310 transmission line, 22 meander line, 23 phase shift circuit, 31 first distribution circuit, 32 second distribution circuit, 33 first directional coupler, 34 second directional coupler, 35 first Wilkinson distribution circuit, 36 second Wilkinson distribution circuit, 51 first antenna, 52 second antenna, 101 ground conductor, 201 first termination register, 202 second termination register, 203, 204 resistor, 211 capacitor, 212 inductor.

1. A decoupling circuit including first and second distribution circuits each distributing one input between two parts and combining two inputs into one, and a transmission line having a predetermined characteristic impedance, said first distribution circuit having first to third terminals and outputting a high frequency signal inputted from said first terminal to said second and third terminals, said second distribution circuit having fourth to sixth terminals and outputting a high frequency signal inputted from said fourth terminal to said fifth and sixth terminals, and said third terminal being connected to an end of said transmission line and said sixth terminal being connected to another end of said transmission line, wherein
a first antenna is connected to said second terminal and a second antenna is connected to said fifth terminal, and a path leading from said first terminal, via said first distribution circuit, said first antenna, space, said second antenna, and said second distribution circuit, to said fourth terminal is defined as a first path and a path leading from said first terminal, via said first distribution circuit, said transmission line, and said second distribution circuit, to said fourth terminal is defined as a second path, and wherein distribution ratios of said first distribution circuit and said second distribution circuit are determined in such a way that a coupling amplitude in said first path and a coupling amplitude in said second path become equal, and a length of said transmission line is also determined in such a way that a coupling phase in said first path and a coupling phase in said second path become opposite to each other within a range between an upper limit frequency and a lower limit frequency of an operating frequency band and a difference between the coupling phase at said upper limit frequency of said operating frequency band and the coupling phase at said lower limit frequency becomes equal between said first path and said second path.

2. (canceled)

3. A decoupling circuit including first and second directional couplers, a transmission line, first and second termination registers, and a ground conductor, said first directional coupler having first to fourth terminals and outputting a high frequency signal inputted from said first terminal to said second and third terminals, but not outputting the high frequency signal to said fourth terminal, said second directional coupler having fifth to eighth terminals and outputting a high frequency signal inputted from said fifth terminal to said sixth and seventh terminals, but not outputting the high frequency signal to said eighth terminal, said third terminal being connected to an end of said transmission line and said seventh terminal being connected to another end of said transmission line, and said fourth terminal being connected to said ground conductor via said first termination register and said eighth terminal being connected to said ground conductor via said second termination register, wherein
a first antenna is connected to said second terminal and a second antenna is connected to said sixth terminal, and a path leading from said first terminal, via said first directional coupler, said first antenna, space, said second antenna, and said second directional coupler, to said fifth terminal is defined as a first path and a path leading from said first terminal, via said first directional coupler, said transmission line, and said second directional coupler, to said fifth terminal is defined as a second path, and wherein coupling amounts of said first directional coupler and said second directional coupler are determined in such a way that a coupling amplitude in said first path and a coupling amplitude in said second path become equal, and a length of said transmission line is also determined in such a way that a coupling phase in said first path and a coupling phase in said second path become opposite to each other within a range between an upper limit frequency and a lower limit frequency of an operating frequency band and a difference between the coupling phase at said upper limit frequency of said operating frequency band and the coupling phase at said lower limit frequency becomes equal between said first path and said second path.

4. (canceled)

5. The decoupling circuit according to claim 1, wherein said first distribution circuit is a first Wilkinson distribution circuit and said second distribution circuit is a second Wilkinson distribution circuit, and isolation between said second and third terminals is ensured in said first Wilkinson distribution circuit and isolation between said fifth and sixth terminals is ensured in said second Wilkinson distribution circuit.

6. The decoupling circuit according to claim 1, wherein said transmission line is a meander line.

7. The decoupling circuit according to claim 3, wherein said transmission line is a meander line.

8. The decoupling circuit according to claim 1, wherein said transmission line is a phase shift circuit comprised of lumped elements, and a plurality of shunt capacitors and a plurality of series inductors are alternately connected to each other in said phase shift circuit.

9. The decoupling circuit according to claim 3, wherein said transmission line is a phase shift circuit comprised of lumped elements, and a plurality of shunt capacitors and a plurality of series inductors are alternately connected to each other in said phase shift circuit.
